(19) United States
(12) Patent Application Publication
(10) Pub. No.: US 2004/0031866 A1
(43) Pub. Date: Feb. 19, 2004

(54) Apparatus for forcing/guiding materials in a hopper to a cutting box

(76) Inventor: Lawrence Burt Gutcho, San Marino, CA (US)

Correspondence Address: Lawrence B. Gutcho, 2275 Huntington Drive, PMB 254, San Marino, CA, 91108, US

(21) Appl. No.: 10/218,433

(22) Filed: Aug. 13, 2002

(51) Int. Cl. B02C 18/16

(52) U.S. Cl. 241/92

(57) ABSTRACT

Three objects functioning inside a shredder hopper or like machine but operated from outside the shredder hopper, with Object One (the “Down Pusher”) forcing materials down vertically from the top of the shredder hopper to the cutting box entry, with Object Two (the “Side Pusher”) forcing materials from the tapering side of the rectangle portion of the cutting box across and over to the plane of operation of Object One, and Object Three (the “Face Pusher”) forcing materials inside the hopper from the entry plane of the hopper.

### CROSS-REFERENCE TO RELATED APPLICATIONS

Not Applicable

### STATEMENT OF FEDERALLY FUNDED RESEARCH AND DEVELOPMENT

Not Applicable

### REFERENCE TO A SEQUENCE LISTING

Not Applicable

### BACKGROUND OF THE INVENTION

The invention pertains to a material improvement in the performance of machines which feed material through a relatively large hopper to a relatively small cutting machine without compromising safety, the art being specifically depicted in connection with what are known as chipper/shredder machines (FIG. 1). Put another way, the invention pertains to a material increase in the safety of such machines since the existing state of the art causes end users to resolve the below described performance problems by unsafe means.

The chipper portion of a chipper shredder chips into small pieces essentially straight pieces of wood of varying width depending on machine capacity. The shredder portion of a chipper/shredder machine shreds brush, bush remnants, tall grasses, leaves and other similar types of plant material. The purpose of the machine is to condense plant refuse into smaller volume, either for easier disposal, or for creation of various types of mulches and composts.

Beyond doubt, a chipper/shredder is an extremely dangerous machine. A hand or foot caught in the cutting box (described below) will be eviscerated, as may be the entire limb as it is pulled into the machine.

The essential components of a chipper/shredder for purposes of describing and patenting my Invention are the cutting box (FIGS. 1, 4 and 5 @ 1) and the shredder hopper (FIG. 1 @ 2,3).

The cutting box contains the knives, flails and other cutting devices that chip and shred. In a nutshell, the cutting devices are attached to a spinning wheel inside the chipper/shredder, which wheel is powered by a gas or electric engine. There are numerous designs of cutting methodologies vis-a vis exactly what is in the cutting box and how the cutting box components move and perform their chore; however, this aspect of chipper/shredder technology is not implicated by the Invention (other than the fact that all of these technologies can shred hands as easily as grasses). For purposes of the Invention, suffice it to say the to-be-shredded materials enter the cutting box through an entry hole (FIGS. 2, 4 and 6 @ 4) (generally rectangular) on the top of the cutting box. However (and the significance of this will be explained below), while the width of the entry hole may be approximately equal to the width of the cutting box, the length of the entry hole is but a fraction of the length of the cutting box. (This is because the rotation of the cutting devices pulls the shredded material through the box toward an exit screen on the side or bottom of the box away from the entry hole, and because if the length of the hole equaled the length of the cutting box, cut and partially cut materials would be spit out at high speed through the top of the box and cause a safety hazard.).

The shredder hopper (FIG. 1 @ 2,3) has at least three purposes. Its first purpose is to load the to-be-shredded materials into the chipper/shredder and deliver them into the cutting box. Since the shredder hopper opening is far, far larger than the cutting box opening, it is fair to say that the shredder hopper also functions as a funneling device. Lastly, the shredder hopper (including various design modifications to the shredder hopper) functions as a safety device. First, shredder hoppers typically contain prominent warning labels. Second, shredder hoppers typically contain plastic or rubber flaps designed to deflect or stop or slow down any material spit back by the cutting box. Third, the shredder hopper provides spatial separation between the hands that load the shredder hopper and the cutting box.

The traditional shredder hopper was either a conical funnel structure positioned above the cutting box entry or a rectangular shredder hopper positioned above the cutting box entry and having one angled side (FIG. 2) tapering the rectangle down to the entry size of the cutting box.

The safety issue implicated by these considerations was a confluence of (a) the flex/springiness/bulkiness/high volume to weight ratio of to-be-shredded brush, tall grasses, bush, etc.; (b) the funneling characteristics of the shredder hopper and (c) the carelessness/stupidity of certain chipper/shredder owners. In a nutshell, the grasses/brush/bush that fit so easily into the top of the funnel/shredder hopper does not gravity feed into the cutting box opening because of the narrowing plane between the funnel/shredder hopper opening and the cutting box entrance (and the analogous available volume decrease between the shredder hopper opening and the usable volume of the (rectangular shredder hopper configuration) angled side tapering the rectangle down to the entry size of the cutting box. Human nature being what it is, the owner would use his/her hand to give a “little push.” No problem-it's an 18 inch funnel/shredder hopper and a “little” 4 inch push. Four inches doesn't always do it; 4 inches become 6 inches, and 10 inches, and the power needed for the push increases as the funnel plane decreases. One strong push to many, and disaster (and lawsuits).

Most manufacturers appear to have responded to this problem with a redesigned shredder hopper, which I will call a horizontal feed shredder hopper (FIG. 2 @ 2). The horizontal feed shredder hopper is constructed such that the plane of the shredder hopper opening and the first section of the shredder hopper (FIGS. 1 and 4 @ 2) is perpendicular or close to perpendicular to the ground, instead of parallel to the ground as found in older models. The shredder hopper then takes a downward angle (FIGS. 1 and 4 @ 5,6) such that the second section of the shredder hopper (FIGS. 1 and 4 @3, FIG. 2) can connect vertically to the cutting box. The cutting box entry is still a fraction of the length of the cutting box (FIGS. 2 and 6 @ 4), and one angled side of the vertical portion of the hopper still tapers the three dimensional space down to the entry size of the cutting box (FIG. 2, FIG. 6 @ 25).

This would appear to be a safer design, since the pushing hand needs to reach around the bend of the shredder hopper angle, which is a tougher stretch. However, this design may in fact be less safe, for two reasons. One, because of the bend of the shredder hopper angle, the user cannot see the cutting box entrance, and is reaching blindly. Two, because of the bend of the shredder hopper angle, it is impossible to use safer methods to push materials down the narrowing funnel, such as, e.g. a branch or stick. Accordingly, chipper/shredder users may be more likely to try to resolve funnel clogs with their hands, which is fundamentally unsafe.

### BRIEF SUMMARY OF THE INVENTION

Three objects functioning inside a shredder hopper or like machine but operated from outside the shredder hopper, with Object One (the “Down Pusher”) forcing materials down vertically from the top of the shredder hopper to the cutting box entry, with Object Two (the “Side Pusher”) forcing materials from the tapering side of the rectangle portion of the cutting box across and over to the plane of operation of Object One, and Object Three (the “Face Pusher”) forcing materials inside the hopper from the entry plane of the hopper.

This Invention solves the functionality problem of jamming/clogging of brush/grasses etc from shredder hopper opening to cutting box entry, and solves it in a way far safer than any methodology current employed.

### BRIEF DESCRIPTION OF THE SEVERAL DRAWINGS

FIG. 1 General view of chipper shredder machine and relationship of hopper to cutting box.

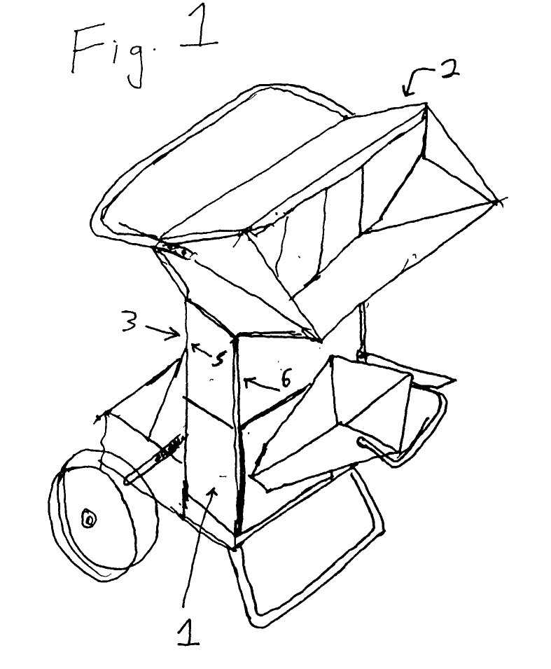

FIG. 2 Vertical portion of horizontal feed hopper leading to entry into cutting box

FIG. 3 View of horizontal feed hopper looking into the horizontal

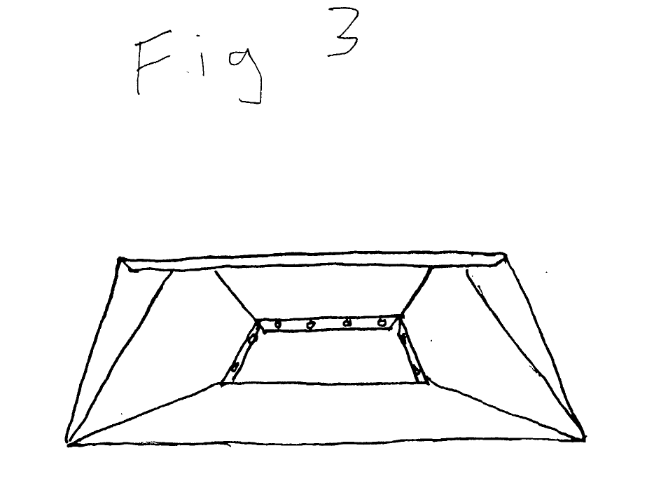

FIG. 4 View of components and construction of Down Pusher and related elements with Down Pusher in the up position.

FIG. 5 Same as FIG. 4 with Down Pusher in down position

FIG. 6 Side view of Side Pusher and angle drop of vertical box

FIG. 7 Re Down Pusher, detail of Leveler/Down Shaft/bottom spring assembly

FIG. 8 Down Shaft handle

FIG. 9 Rotation of Side Pusher in vertical box

FIG. 10 Overview of Side Pusher fulcrum lever

FIG. 11 Detail of Side Pusher fulcrum lever

FIG. 12 More detail of Side Pusher fulcrum lever

FIG. 13.Overview and detail of Face Pusher

### DETAILED DESCRIPTION OF THE INVENTION

Reference is made to background of invention with respect to the problem being solved by the Invention.

“The embodiments described below are merely exemplary and are not intended to limit the invention to the precise forms disclosed. Instead, the embodiments were selected for description to enable one of ordinary skill the art to practice the invention.”

“It should be understood that the materials described may be alternatively formed from other materials of comparable function and durability, and that in many instances dimensions are serviceable but not the only dimensions that will accomplish the spirit of the inventions.”

General Description of Claim No. 1:

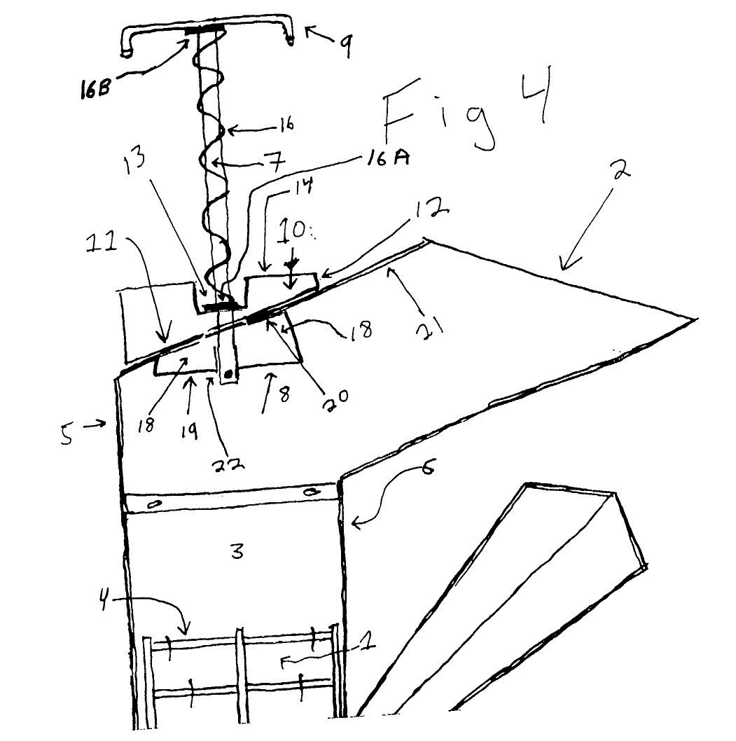

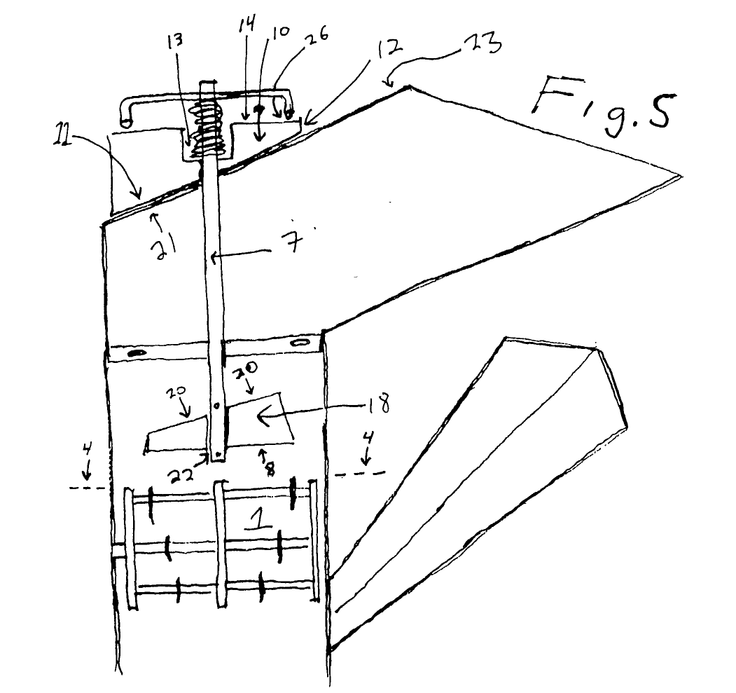

A modification to horizontal feed chipper/shredders whereby a guided, secured object (hereinafter the “Down-Pusher”) is moved up and down through the interior of the hopper (e.g. plane of motion perpendicular to the ground) (FIGS. 4 and 5) to force materials clogging in the Down-Pusher's area of operation down to the cutting box entrance.

Further Description of Claim No. 1 Coupled With Representative Method of Construction of Claim No. 1

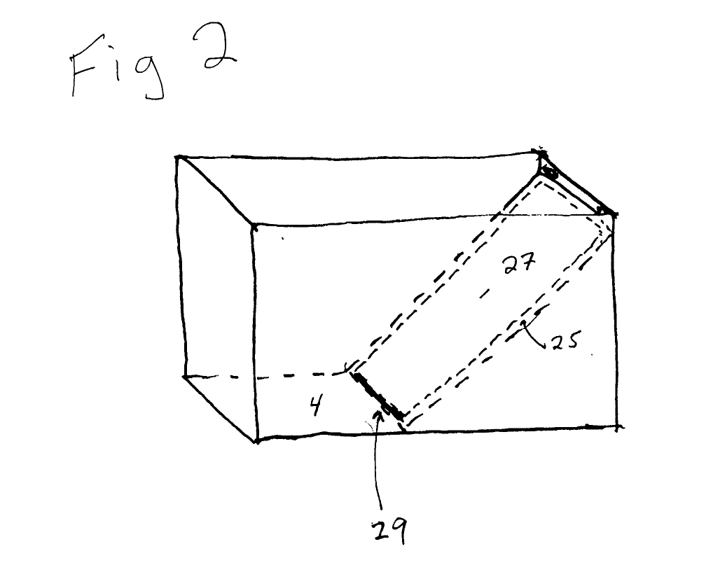

fabricate two inch by two inch wood or other media (the “Down Shaft”) (FIGS. 4 and 5 @ 7), of a length which when construction is complete as described below will push the bottom plane of the below described Down Pusher (FIGS. 4 and 5 @ 8) to approximately one inch of the plane constituting the entry to the cutting box (FIGS. 2,5 and 6 @ 4);

fabricate wood, metal or plastic object (the “Leveler”) (FIGS. 4 and 5 @ 10)

of a top plane width and length equal to approximately 95 percent of the width and length of the plane constituting the entry to the cutting box (FIGS. 2, 5 and 6 @ 4);

of a trapezoidal shape such that there is one non-parallel side of the trapezoid that will sit flush on the angle of the hopper top when the opposite side of the trapezoid is parallel to the plane of the opening to the cutting box (FIGS. 4 and 5 @ 11);

and such that the shorter of the two parallel sides of the trapezoid (FIGS. 4 and 5 @ 12) is of the length necessary so that the trapezoid will accommodate the square hole described next below.

cut square hole (FIGS. 4 and 5 @ 13) in center of top plane of Leveler (FIGS. 4 and 5 @ 14)

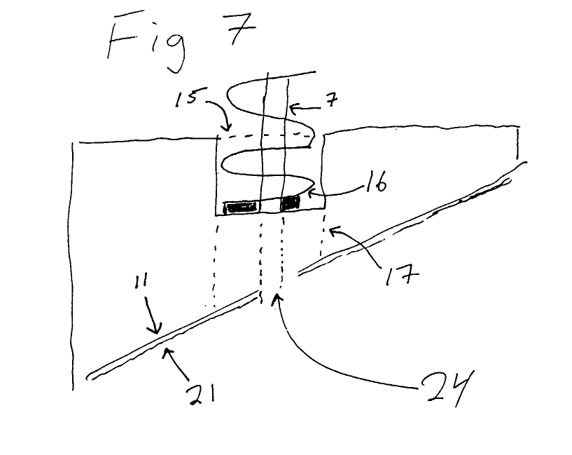

the top plane of which hole (FIG. 7 @ 15) is sufficient to accommodate and brace the below-described spring (FIGS. 4 and 5 @ 16) wrapped around the Down Shaft (FIGS. 4 and 7 @ 7, 16) and

the depth of which is at least one-half inch from the highest point on the hopper when measured by extending the line of the sides of the hole straight down (FIG. 7 @ 17) when the Leveler is positioned such that its top plane is centered in the plane of the entry to the cutting box.

utilizing wood or other media, construct “Down Pusher” (FIGS. 4 and 5 @ 18) with

bottom and top length and width equal to approximately 80% of the bottom length and width of the plane of the opening to the cutting box (FIGS. 2, 5 and 6 @ 4),

bottom plane (FIG. 4 @ 19) parallel with the plane of the opening to the cutting box (FIGS. 2, 5 and 6 @ 4),

top plane (FIGS. 4 and 5 @ 20) parallel to the angle of the portion of the top of the hopper directly above the cutting box (FIGS. 4 and 5 @ 21)

and a short side height of at least two inches.

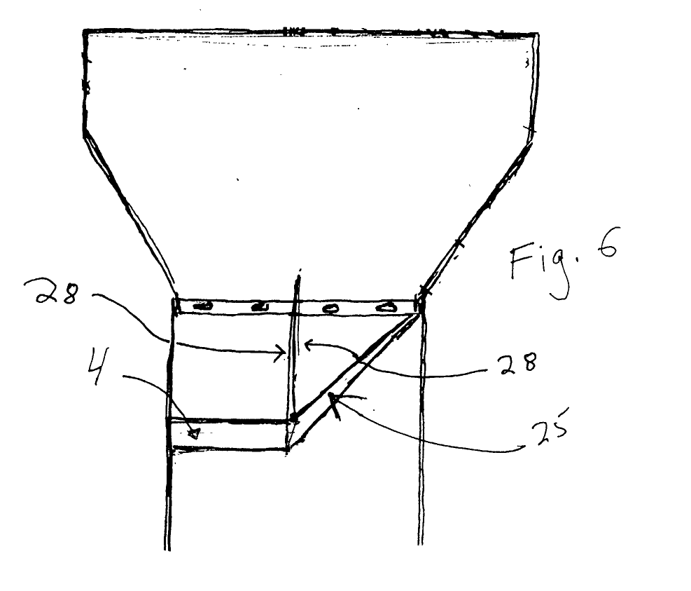

cut two inch by two inch hole in center of Down Pusher (FIGS. 5 and 6 @ 22), with center being determined by the length and width of the bottom plane but hole being cut from the top plane and penetrating to a depth of not more than one inch from the bottom plane.

center Leveler on top plane of hopper (FIG. 5 @ 23) so that top plane of Leveler (FIGS. 4 and 5 @ 14) is centered over the width and length of the plane constituting the opening to the cutting box (FIGS. 2, 5 and 6 @ 4)

attach Leveler to top plane of hopper using ¼ inch bolts and lock nuts such that bolts protruding through the bottom of the Leveler will not touch the Down Pusher (FIGS. 4 and 5 @ 18) when the Down Pusher is centered above the plane of the cutting box (FIGS. 2, 5 and 6 @ 4).

cut two inch by two inch hole in center of center of hole cut in Leveler that extends through bottom angular plane and through the hopper top (FIG. 7 @ 24);

grind out the two sides of the hole in the hopper that are perpendicular to the angled plane of the hopper to accommodate absolute vertical (perpendicular to flat ground) movement of the Down Shaft;

insert spring onto Down Shaft with bottom of spring affixed to hole cut in Leveler (FIG. 4 @ 16, 13 and 16A

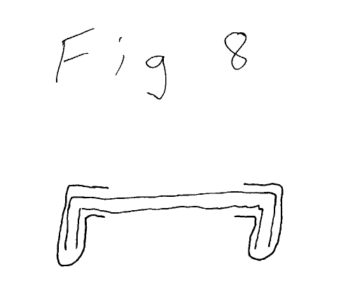

affix to Down Shaft perpendicular handle with parallel dropped, rubber capped tips (FIG. 4 @ 9) which slide onto handle at horizontal plane (FIG. 8) with horizontal length of handle being such that when pushed down vertical rubber tips will strike (FIG. 5 @ 26) below-described Leveler (FIGS. 4 and 5 @ 10) approximately one inch from edges of below described Leveler.

Handle can be two inch by two inch wood or other media affixed to Down Shaft by top bolting and side bracketing,

one inch by two inch affixed by placing on either side of the upright two by two and side bolting, or

one-piece fabrication.

affix top of spring to flat underside plane of handle (FIG. 4 @ 16, 16B)

affix Down Shaft to Down Pusher by side bolting with ¼ inch bolts and lock nuts or by straight Simpson ties.

for each model of Chipper/Shredder, record all dimensions of all parts to facilitate construction, pre-drilling of holes, etc.

General Description of Claim No. 2:

A modification to horizontal feed chipper/shredders whereby a guided, secured, limited length of movement flat piece of steel (FIG. 2 @ 27) (hereinafter the “Side-Pusher”) resting on the angle drop (FIGS. 2 and 6 @ 25, FIG. 2 @ 27) of the vertical box (FIG. 2) is rotated via fulcrum and lever such that the bottom plane of the steel plate pivots and the top plane rotates to a point (FIG. 6 @ 28) just prior to the three dimensional plane of operation of the Down-Pusher.

Further Description of Claim No. 2 Coupled With Representative Method of Construction of Claim No. 2

fabricate flat piece of steel with dimensions slightly less than the plane area of the angle drop (FIG. 2 @ 27)

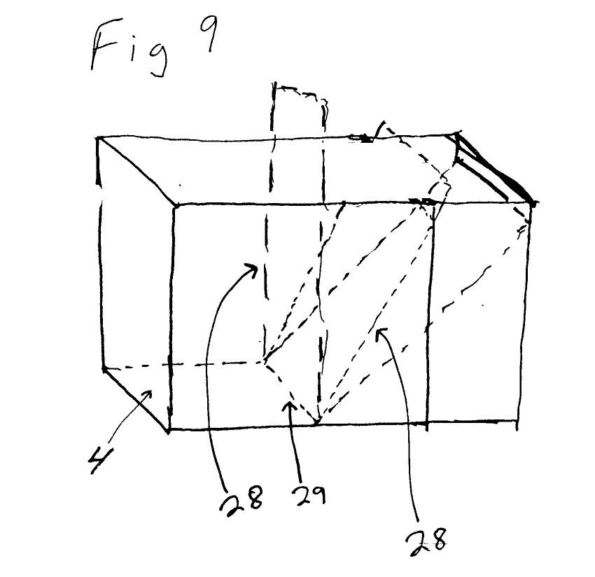

attach to bottom of angle drop with bolt (FIGS. 2 and 9 @ 29) that allows plate to pivot (FIGS. 6 and 9 @ 28)

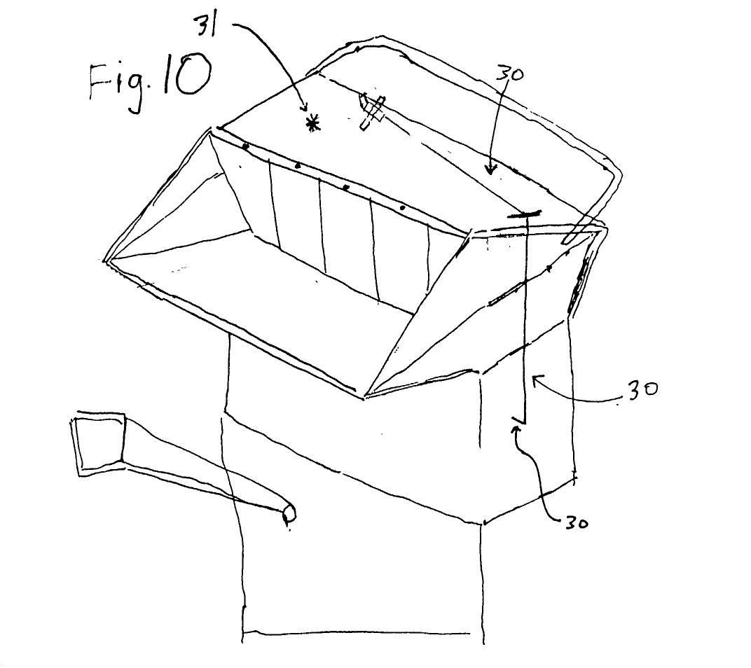

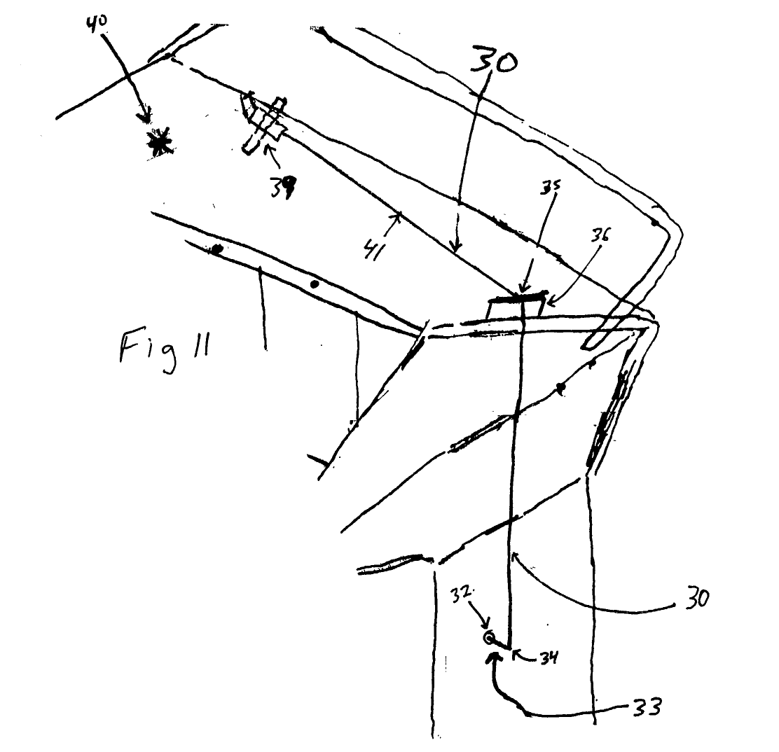

pivot plate by pulling up on below described two angle fulcrum lever (FIG. 10 @ 30 for general positioning (FIG. 10 at 31 shows general location of Leveler), FIG. 11 for detail of lever) welded to back of plate with two opposite right angle brackets and which lever

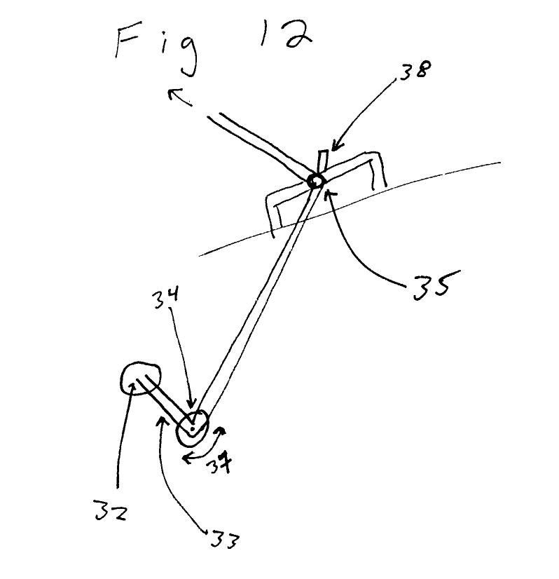

protrudes through hole in side of hopper where plate rests (FIGS. 11 and 12 @ 32 as to hole, @ 33 as to first section of lever)

pivots at first angle joint (FIGS. 11 and 12 @ 34 as to first angle joint; FIG. 12 @ 37 as to pivoting motion)

has hole for pivot bolt of fulcrum at second angle joint (FIG. 11 and 12 @ 35 as to second angle joint and hole, (FIG. 11 and 12 @ 36 as to fulcrum as attached to top of hopper)

has stop point on fulcrum (FIG. 12 @ 38) so lever operation stops at point where steel plate reaches plane perpendicular to flat ground (FIG. 9@28)

has three way easy grip handles (FIG. 11 @ 39) at corner of hopper near Leveler (FIGS. 11 @ 40 with asterisk showing general location of Leveler.

has free fall weight on side of lever (FIG. 11 @ 41) between fulcrum and Leveler so that steel plate will return to angled position (e.g. lever handle comes down) by virtue of its own weight

Description of Claim No. 3 Coupled with Representative Method of Construction

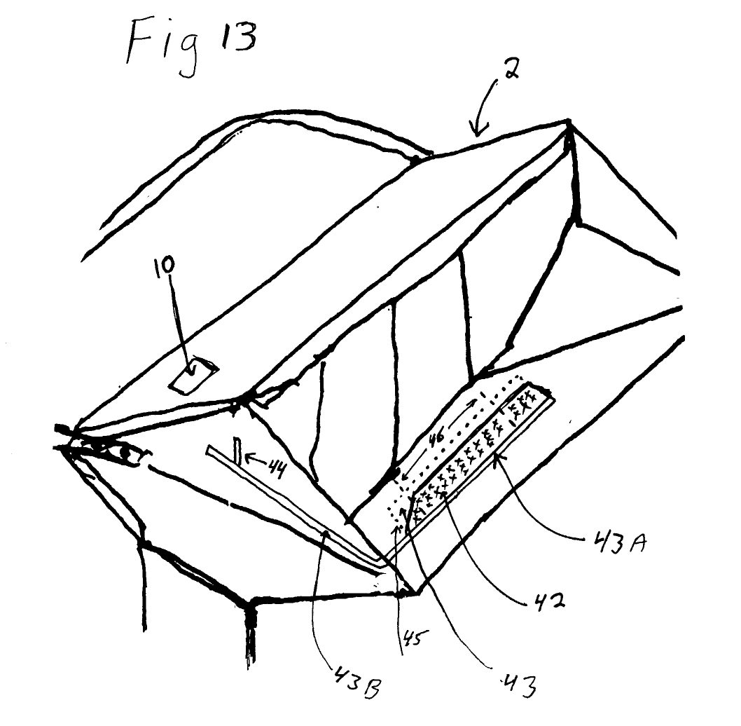

Spring loaded light metal plate (the “Face Pusher”) that is mounted (FIG. 13) to upper side of lower face (FIG. 13 @, FIG. 10 @ 32) of hopper entry by one angle lever (FIG. 13 @ 43A and 43B) that is attached to the base of the plate at 43A and the bottom of which lever is attached to two metal tracks (FIG. 13 @ 46) perpendicular to lever and extending into hopper

which plate is spring loaded so that its unengaged position is perpendicular to low face of hopper (FIG. 13 @ 42 cross hatching) but will rotate forward to flush with the plane of the lower face of the hopper (FIG. 13 @ 45 dotted line) to accommodate hopper loading and then spring back to perpendicular.

with lever giving complete resistance and rigidity to backward rotation from the perpendicular

with lever protruding out through side of hopper closest to Leveler (location of Leveler shown at FIG. 43 @ 10) and horizontal slit cut in hopper side along path of lever operation such that so handle (FIG. 13 @ 44) can to move lever towards rear of hopper thereby using perpendicular plate to sweep material into maw of hopper, with slit ending just before plane of operation of Down Pusher.

The foregoing description of the inventions is illustrative only, and is not intended to limit the scope of the invention to the precise terms set forth. Although the inventions have been described in detail with respect to certain embodiments, variations and modifications exist within the scope and spirit of the invention as described in the following claims.

I claim as my inventions

1. A modification to machines where materials are fed into a horizotal horizontal or quasi horizontal hopper and are to proceed to a cutting box with an entry plane of an area less than the area of the hopper opening whereby a guided, secured object (hereinafter the “down-pusher”) is moved up and down through the interior of the hopper (e.g. plane of motion perpendicular to the ground)) to force materials clogging in the down-pusher's area of operation down to the cutting box entrance:

2. With respect to claim 1, a modification to horizontal feed chipper/shredders whereby a guided, secured object (hereinafter the “Down-Pusher”) is moved up and down through the interior of the hopper (e.g. plane of motion perpendicular to the ground) to force materials clogging in the Down-Pusher's area of operation down to the cutting box entrance.

3. With respect to claim 1, a modification of horizontal feed chipper/shredders or like machines utilizing a two inch by two inch wood or other media (the “Down Shaft”) of a length which when construction is complete as described below will push the bottom plane of the below described Down Pusher) to approximately one inch of the plane constituting the entry to the cutting box);
utilizing a metal or plastic object (the “Leveler”)
of a top plane width and length equal to approximately 95 percent of the width and length of the plane constituting the entry to the cutting box;
of a trapezoidal shape such that there is one non-parallel side of the trapezoid that will sit flush on the angle of the hopper top when the opposite side of the trapezoid is parallel to the plane of the opening to the cutting box;
and such that the shorter of the two parallel sides of the trapezoid is of the length necessary so that the trapezoid will accommodate the square hole described next below.
with square hole) in center of top plane of Leveler)
the top plane of which hole is sufficient to accommodate and brace the below-described spring wrapped around the Down Shaft and
the depth of which is at least one-half inch from the highest point on the hopper when measured by extending the line of the sides of the hole straight down when the Leveler is positioned such that its top plane is centered in the plane of the entry to the cutting box.
utilizing wood or other media, construct “Down Pusher” with
bottom and top length and width equal to approximately 80% of the bottom length and width of the plane of the opening to the cutting box
bottom plane parallel with the plane of the opening to the cutting box,
top plane parallel to the angle of the portion of the top of the hopper directly above the cutting box
and a short side height of at least two inches.
with two inch by two inch hole in center of Down Pusher, with center being determined by the length and width of the bottom plane but hole being cut from the top plane and penetrating to a depth of not more than one inch from the bottom plane.
with Leveler centered on top plane of hopper so that top plane of Leveler is centered over the width and length of the plane constituting the opening to the cutting box
with spring on Down Shaft with bottom of spring affixed to hole cut in Leveler and top of spring affixed to handle such that Down Pusher will be in the up position at rest, and when pushed down the spring is compressed such the Down Pusher will be returned to up position by force of spring
with handle on Down Shaft securing top of spring with parallel dropped, rubber capped tips with size of handle being such that when pushed down vertical rubber tips will strike below-described Leveler.

4. A modification to horizontal feed chipper/shredders and like machines whereby a guided, secured, limited length of movement flat piece of steel (hereinafter the “Side-Pusher”) resting on the angle drop of the vertical box is rotated via fulcrum and lever such that the bottom plane of the steel plate pivots and the top plane rotates to a point just prior to the three dimensional plane of operation of the Down-Pusher.

5. With respect to claim 4, A modification to horizontal feed chipper/shredders and like machines whereby a guided, secured, limited length of movement flat piece of steel (hereinafter the “SidePusher”) resting on the angle drop of the vertical box is rotated via fulcrum and lever such that the bottom plane of the steel plate pivots and the top plane rotates to a point just prior to the three dimensional plane of operation of the Down-Pusher.

6. A modification to chipper/shredders and like machines whereby a spring loaded light metal plate (the “Face Pusher”) is mounted) to upper side of lower face of hopper entry by one angle lever) that is attached to the base of the plate and the bottom of which lever is attached to two metal tracks perpendicular to lever and extending into hopper.
which plate is spring loaded so that its unengaged position is perpendicular to low face of hopper but will rotate forward to flush with the plane of the lower face of the hopper to accommodate hopper loading and then spring back to perpendicular.
with lever giving complete resistance and rigidity to backward rotation from the perpendicular
with lever protruding out through side of hopper closest to Leveler and horizontal slit cut in hopper side along path of lever operation such that so handle can to move lever towards rear of hopper thereby using perpendicular plate to sweep material into maw of hopper, with slit ending just before plane of operation of Down Pusher.

7. With respect to claim 6, a modification to chipper/shredders whereby a spring loaded light metal plate (the “Face Pusher”) is mounted) to upper side of lower face of hopper entry by one angle lever) that is attached to the base of the plate and the bottom of which lever is attached to two metal tracks perpendicular to lever and extending into hopper.
which plate is spring loaded so that its unengaged position is perpendicular to low face of hopper but will rotate forward to flush with the plane of the lower face of the hopper to accommodate hopper loading and then spring back to perpendicular.
with lever giving complete resistance and rigidity to backward rotation from the perpendicular
with lever protruding out through side of hopper closest to Leveler and horizontal slit cut in hopper side along path of lever operation such that so handle can to move lever towards rear of hopper thereby using perpendicular plate to sweep material into maw of hopper, with slit ending just before plane of operation of Down Pusher.
